(19) United States
(12) Patent Application Publication
(10) Pub. No.: US 2013/0180748 A1
(43) Pub. Date: Jul. 18, 2013

(54) PNEUMATIC TORQUE IMPULSE WRENCH WITH STEPPED SHUT-OFF FUNCTION

(71) Applicant: Per Thomas Soderlund, Varmdo (SE)

(72) Inventor: Per Thomas Soderlund, Varmdo (SE)

(73) Assignee: ATLAS COPCO INDUSTRIAL TECHNIQUE AB, Stockholm (SE)

(21) Appl. No.: 13/824,696

(22) PCT Filed: Oct. 24, 2011
(86) PCT No.: PCT/EP11/68532

§ 371 Date: Mar. 18, 2013

(30) Foreign Application Priority Data
Oct. 27, 2010 (SE) 1051117-8

(51) Int. Cl. B25B 23/145

(52) U.S. Cl. CPC B25B 23/145
USPC 173/176

(57) ABSTRACT

A pneumatic torque impulse wrench comprises a housing (10), a motor (15), a hydraulic impulse unit (20) including an inertia drive member (21) and intermittently coupling the motor (15) to an output shaft (18), a shut-off valve (23) controlling the pressure air supply to the motor (15), and an activating mechanism (25) arranged to shift the shut-off valve (23) from a fully open position to a closed position via one or more partly closed positions. An activating mechanism (25) for shifting the shut-off valve (23) comprises a retardation responsive inertia element (28) movably supported on the inertia drive member (21), and a trip element (24) displaceable by the inertia element (28) and arranged to initially support the shut-off valve (23) in a fully open position during a screw joint tightening process and in succeeding one or more partly open positions for obtaining a power reduction of the motor (15) when approaching a target torque level.

The invention relates to a pneumatic torque impulse wrench comprising a housing, a pneumatic rotation motor, an output shaft, an impulse unit including a inertia drive member connected to the motor and intermittently coupling the motor to the output shaft, and a power shut-off mechanism including an actuating mechanism responsive to the retardation magnitude of the inertia drive member, and an shut-off valve operated by the actuating mechanism for cutting off the pressure air supply to the motor at the attainment of a preset target torque level.

In particular, the invention concerns a pneumatic torque impulse wrench of the above type in which the power shut-off mechanism comprises a trip means to be activated by a retardation responsive inertia member to release the shut-off valve for movement from a normally open position towards a closed position as the magnitude of the delivered torque impulses has reached a certain level corresponding to the preset target torque level.

An impulse wrench of the above described type is described in U.S. Pat. No. 5,082,066.

A problem concerned with pneumatic torque impulse wrenches of the above type is that the motor is supplied with pressure air at full pressure all the way up to the target torque level where the shut-off valve is abruptly closed to cut off pressure supply to the motor to thereby stop further impulse generation. This means that there is a risk that the last couple of impulses will be too strong and cause an undesired torque overshoot, particularly in stiff joints having a steep torque growth per angle of rotation characteristic. So, there is a wish to accomplish a reduction of motor power as the tightening process approaches the target torque level so as to reduce the motor speed and hence the kinetic energy being transferred to the output shaft at each impulse, and thereby minimizing the risk for torque overshoot.

It is an object of the invention to provide a pneumatic torque impulse wrench of the above described type by which the risk for torque overshoot is substantially reduced.

It is a further object of the invention to provide a pneumatic torque impulse wrench of the above described type wherein the pressure air supply to the motor is shut off in one or more steps as the tightening operation approaches the target torque level.

Still further objects and advantages of the invention will appear from the following specification and claims.

A preferred embodiment of the invention is described below in detail with reference to the accompanying drawing.

In the drawing

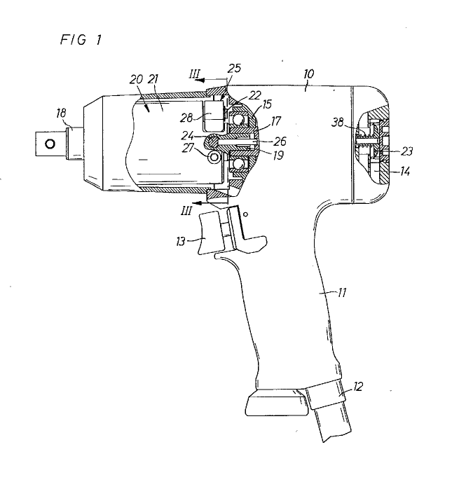

FIG. 1 shows a side view of a pneumatic impulse wrench according to the invention.

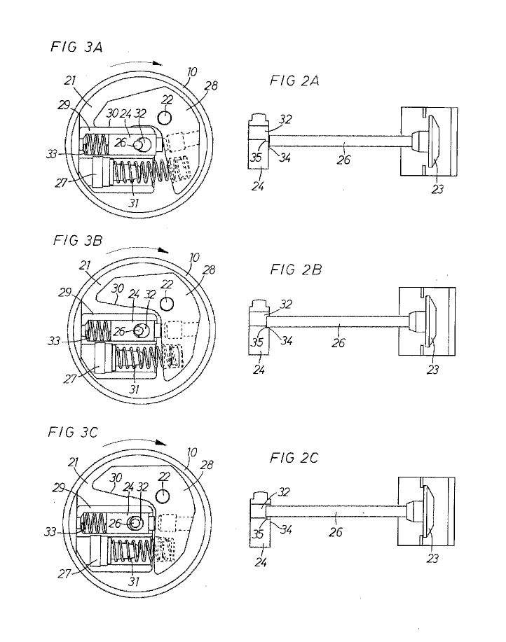

FIG. 2A shows a schematic view of the power shut-off mechanism comprised in the power wrench in FIG. 1 and illustrating the shut-off mechanism in a fully open position.

FIG. 2B shows the same view as FIG. 2A but illustrates the shut-off mechanism in a partly closed position.

FIG. 2C shows the same view as FIG. 2A but illustrates the shut-off mechanism in a fully closed position.

FIG. 3A shows an end view of the impulse unit along line III-III in FIG. 1, and illustrates the activating mechanism in a rest position maintaining the shut-off valve in a fully open position.

FIG. 3B shows the same view as FIG. 3A, but illustrates the activating mechanism in a partly activated position maintaining the shut-off valve in a partly open position.

FIG. 3C shows the same view as FIG. 3A, but illustrates the activating mechanism in a fully activated position with the shut-off valve shifted to its fully closed position.

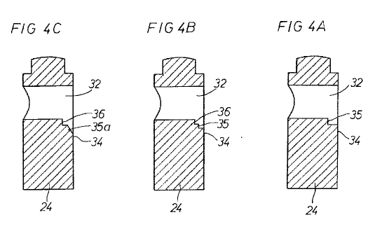

FIG. 4A shows a longitudinal section through a trip element as included in one embodiment of the invention.

FIG. 4B shows a longitudinal section through a trip element according to another embodiment of the invention.

FIG. 4C shows a longitudinal section through a trip element according to still another embodiment of the invention.

The power wrench illustrated in the drawing figures is a pistol type pneumatic impulse wrench comprising a housing 10 with a handle 11. The handle 11 is provided with a connector piece 12 for a pressure air conduit and includes a throttle valve operated by a trigger 13. The throttle valve is arranged to control the pressure air supply through a pressure air supply passage 14 in the housing 10 communicating with a pneumatic motor 15. The motor 15 comprises a rotor 17 which is connected to a square ended output shaft 18 via a hydraulic impulse unit 20. The output shaft 18 is intended to carry a nut socket for connection to a screw joint to be tightened. The impulse unit 20 comprises an inertia drive member 21 which has a rear extension 19 coupled to the motor rotor 17. In a well known way the inertia drive member 21 also comprises an internal fluid chamber into which the rear end of the output shaft 18 extends, and wherein the inertia drive member 21 is intermittently coupled to the output shaft 18 to thereby transfer kinetic energy from the drive member 21 to the output shaft 18 in the form of torque impulses. This known arrangement is not described in further detail.

The air flow through the pressure air supply passage 14 is automatically shut-off by a shut-off valve 23 as a predetermined torque level is obtained in a screw joint being tightened. This torque level corresponds to a certain retardation magnitude of the inertia drive member 21, and an activating mechanism 25 is arranged to accomplish an automatic closing of the shut-off valve 23 as the intended target torque level is reached. This activating mechanism 25 comprises on one part a valve rod 26 which is secured to the shut-off valve 23 and extends axially through the motor rotor 17. On the other part the activating mechanism 25 comprises an L-shaped inertia element 28 movably supported on the inertia drive member 21 via a pivot 22, and a trip element 24 moveably guided in a transverse direction on the inertia drive member 21 and displaceable by the inertia element 28. As described in further detail below the valve rod 26 is arranged to be supported in an endwise manner on the trip element 24 to maintain the shut-off valve 23 in one or more open positions.

As illustrated in FIGS. 3A-C, one of the legs of the L-shaped inertia element 28 is formed with a stop heel 30 for defining a rest position of the inertia element 28 in contact with a wall portion 29 of the inertia drive member 21, and a spring 31 is employed to bias the inertia element 28 toward that rest position. The spring 31 is backed by an adjustable set screw 27. The trip element 24 is displaceably guided relative to the inertia drive member 21 and biased by a spring 33 into contact with the inertia element 28.

The trip element 24 is provided with a primary contact surface 34 on which the valve rod 26 is arranged to be endwise supported to maintain the shut-off valve 23 in a fully open position and thereby enable a full flow of pressure air to the motor 15. An aperture 32 in the trip element 24 is arranged to receive the end portion of the valve rod 26 and shift the shut-off valve 23 to a closed position.

As illustrated in FIGS. 2A-C and 4A the trip element 24 is formed with a shoulder 35 located at the edge of the aperture 32 and forming a secondary contact surface for endwise supporting the valve rod 26 in a partly closed position of the shut-off valve 23. In this position the shut-off valve 23 will let through a limited pressure air flow only to reduce the motor power. In FIG. 4B there is illustrated an alternative trip element design wherein a second shoulder 36 is provided to form a third valve rod supporting contact surface in which the shut-off valve 23 is maintained in a further flow restrictive position to further limit the pressure air flow to the motor and further reduce the motor power.

The operation of the shut-of valve activating mechanism 25 is described with reference to FIGS. 2A-C and 3A-C, and it is assumed that the power wrench is applied on a screw joint to be tightened and that the exerted torque impulses accomplish a stepwise increase of the installed torque in the screw joint. During the initial stage of the screw joint tightening process the output torque is low and the shut-off valve 23 is maintained in its fully open position to supply a full flow of pressure air to the motor 15. In this position the valve rod 26 is endwise supported on the primary contact surface 34 on the trip element 24. See FIG. 2-A. However, an increasing output torque of the delivered torque impulses results in an increased retardation magnitude in the inertia drive member 21. The inertia drive member 21 rotates in a direction shown by the arrow in FIGS. 3A-C, and abrupt retardations occurring at repeated impulses result in inertia related forces acting on the L-shaped inertia element 28. At a certain retardation magnitude, determined by the setting of the set screw 27 backing the spring 31, the inertia element 28 will start moving about the pivot 22, against the action of the spring 31, to thereby accomplish a displacement of the trip element 24. At a certain retardation magnitude of the inertia drive member 21 the displacement of the trip element 24 will be just enough to make the valve rod 26 move its support from the primary contact surface 34 on the trip element 24 to the first shoulder 35. This short axial displacement of the valve rod 26 makes the shut-off valve 23 move into a partly closed position resulting in a restricted pressure air flow to the motor 15 and, hence, a reduced power output of the motor 15. See FIG. 2B.

At a further delivered torque impulse the delivered torque has increased still, which results in an increased retardation magnitude in the inertia drive member 21. This makes the inertia element 28 displace the trip element 24 further. See FIG. 3C. Now, even the first shoulder 35 is moved out of engagement with the valve rod 26 which results in the latter looses its endwise support and falls down into the aperture 32 causing a full closure of the shut-off valve 23. See FIG. 2C.

The shut-off valve 23 is biased toward open position by a reset spring 38, but due to the air pressure drop across the valve 23 a closing force dominating the force of the reset spring 38 urges the shut-off valve 23 toward closed position. This means that the valve rod 26 is always biased into an endwise support contact with the primary contact surface 34 and the shoulder 35 as long as the throttle valve is open and the power wrench is in operation. As the intended final torque target is reached and the valve rod 26 has entered the aperture 32 the shut-off valve 23 is closed and the motor stops and the tightening process is completed. When the throttle valve 23 is closed and the pressure drop across the shut-off valve 23 is discontinued the reset spring 38 is able to return the shut-off valve 23 to its fully open position. At the same time the valve rod 26 is withdrawn from the aperture 32 such that the trip element 24 is free to return to its original position thereby resuming its contact with the inertia element 28. Now, a full screw joint tightening cycle is completed, and the power wrench is ready for another tightening cycle starting with the valve rod 26 being supported on the primary contact surface 34 on the trip element 24.

In an alternative embodiment of the invention the trip element 24 is provided with a second shoulder 36, lower than the first shoulder 35 and intended to support the valve rod 26 at a further increased torque magnitude, whereby is provided for a further flow restricting position of the shut-off valve 23 and, hence, a further reduced motor power.

In a still further embodiment of the invention, illustrated in FIG. 4C, the first shoulder 35a on the trip element 24 is inclined so as to provide for a successive movement of the valve rod 26 between the primary contact surface 34 and the second shoulder 36. This means that a successive movement of the shut-off valve 23 is obtained between the fully open position and a partly closed position at increasing retardation magnitudes within a certain torque interval.

The above described stepwise movement of the shut-off valve 23 from a fully open position to a closed position is important in preventing the torque impulses delivered close to the target torque level from being too strong and causing an undesirable torque overshoot. The reduction of the motor power and, hence, the kinetic energy of each delivered impulse when approaching the intended target torque level is a guarantee for not getting an undesired torque overshoot and a possible damage to the screw joint being tightened.

1. Pneumatic torque impulse wrench comprising a housing (10) with a pressure air supply passage (14), a pneumatic motor (15), an output shaft (18), an impulse unit (20) intermittently coupling the motor (15) to the output shaft (18) and including an inertia drive member (21) connected to the motor (15), a shut-off valve (23) provided with a valve rod (26) and arranged to cut off the pressure air supply to the motor (15) at the attainment of a target torque level, a shut-off valve (23) activating mechanism (25) supported on the inertia drive member (21) and comprising a movable retardation responsive inertia element (28), and a trip element (24) displaceable by the inertia element (28) and provided with a primary contact surface (34) for endwise supporting the valve rod (26) in a fully open position of the shut-off valve (23), and the trip element (24) is provided with an aperture (32) for receiving the valve rod (26) at displacement of the trip element (24) and the contact surface (34) out of alignment with the valve rod (26) to thereby enable movement of the shut-off valve (23) from a fully open position towards a closed position, characterized in that the trip element (24) comprises one or more shoulders (35,36) located at the edge of the aperture (32) and forming one or more secondary contact surfaces for endwise supporting the valve rod (26) in one or more partly closed positions of the shut-off valve (23), thereby accomplishing a stepwise closing of the shut-off valve (23) at successively increasing retardation magnitudes of the inertia drive member (21) when approaching the target torque level.

2. Impulse wrench according to claim 1, wherein one of said shoulders (35a) has an inclined contact surface providing successively advanced support positions of the valve rod (26) in the closing direction of the shut-off valve (23), each position being dependent on the actual incremental displacement of the trip element (24) at successively increasing retardation magnitudes of the inertia drive member (21).
